(19) United States
(12) Patent Application Publication
(10) Pub. No.: US 2023/0342549 A1
(43) Pub. Date: Oct. 26, 2023

(54) LEARNING APPARATUS, ESTIMATION APPARATUS, METHODS AND PROGRAMS FOR THE SAME

(71) Applicant: NIPPON TELEGRAPH AND TELEPHONE CORPORATION, Tokyo (JP)

(72) Inventors: Junji WATANABE, Tokyo (JP); Aiko MURATA, Tokyo (JP)

(73) Assignee: NIPPON TELEGRAPH AND TELEPHONE CORPORATION, Tokyo (JP)

(21) Appl. No.: 17/761,950

(22) PCT Filed: Sep. 20, 2019
(86) PCT No.: PCT/JP2019/037059

§ 371 Date: Mar. 18, 2022

(51) Int. Cl. G06F 40/274

(52) U.S. Cl. CPC G06F 40/274

(57) ABSTRACT

An estimation apparatus includes an estimation unit configured to estimate a non-fixed ambient environment of future by using an estimation model, the estimation model being for receiving, as an input, at least a time series of two or more psychological state sensitivity expression words up to a certain time-point to estimate a non-fixed ambient environment after the certain time-point, the non-fixed ambient environmental information being information related to a non-fixed ambient environment that is an ambient environment not uniquely defined for a location, the estimation unit estimating the non-fixed ambient environment of the future, based at least on the input two or more psychological state sensitivity expression words and an input order of the psychological state sensitivity expression words.

### TECHNICAL FIELD

The present invention relates to a technique for estimating an ambient environment such as weather information from psychological state sensitivity expression words including onomatopoeias.

### BACKGROUND ART

In NPL 1, an impression of the whole onomatopoeia is quantized by a model for predicting an impression of an onomatopoeia from phonological elements forming the onomatopoeia such as kinds of consonants and vowels, and presence or absence of a voiced sound, and the like.

### CITATION LIST

### Non Patent Literature

NPL 1: Yuichiro Shimizu, Ryuichi Doizaki, Maki Sakamoto, “A System to Estimate an Impression Conveyed by Onomatopoeia”, Journal of Japanese Society for Artificial Intelligence, Vol. 29, 1, pp. 41-52, 2014.

### SUMMARY OF THE INVENTION

### Technical Problem

The related art estimates an impression made from an onomatopoeia, but does not estimate an ambient environment of a user using the onomatopoeia.

The present invention aims to provide an estimation apparatus for estimating a non-fixed ambient environment of the future, based on psychological state sensitivity expression words until now, a learning apparatus for training a model used in estimating the non-fixed ambient environment, methods therefor, and programs therefor.

Note that a psychological state sensitivity expression word represents a psychological state of an object person at a point of time, and is a generic term of words categorized into, for example, at least any of onomatopoeia and exclamation. The onomatopoeia is a generic term of words categorized into, for example, at least any of onomatopoeic word, mimetic word that represents a non-auditory external phenomenon, and mimetic word that represents a psychological state. Here, the onomatopoeic word represents an actual sound in a verbal sound, the mimetic word that represents a non-auditory external phenomenon represents a non-sound sensation in a verbal sound, and the mimetic word that represents a psychological state represents a psychological state in a verbal sound. Note that the exclamation may be referred to as an interjection. Hereinafter, although a case that the psychological state sensitivity expression word is an onomatopoeia is described, a case that the psychological state sensitivity expression word is an exclamation can also be processed similarly.

The “non-fixed ambient environment” here is a term used concerning the ambient environment to distinguish from a “fixed ambient environment”. The “fixed ambient environment” is an ambient environment around an object person and is uniquely determined for a location. For example, a “food and drink facility”, an “amusement facility”, an “XX amusement park”, a “YY zoo”, etc. are the “fixed ambient environments”. In contrast, the “non-fixed ambient environment” is an ambient environment around an object person and is not uniquely defined for a location, that is, an environment changing with a change in time, and is, for example, weather information of air temperature, humidity, rainfall amount, earthquake, and the like. For example, the foregoing weather information or the like, which changes with a change in time even at the same location, is an ambient environment not uniquely defined for the location, and can hence be said to be a “non-fixed ambient environment”.

### Means for Solving the Problem

In order to solve the above problem, according to an aspect of the present invention, a learning apparatus includes a storage unit that stores at least a plurality of psychological state sensitivity expression words for learning and non-fixed ambient environmental information for learning, which is information related to a non-fixed ambient environment that is an ambient environment not uniquely defined for a location, when a psychological state sensitivity expression word for learning of the plurality of psychological state sensitivity expression words for learning is emitted, and a learning unit that trains an estimation model, which receives, as an input, at least a time series of two or more psychological state sensitivity expression words of the plurality of psychological state sensitivity expression words for learning up to a certain time-point to estimate a non-fixed ambient environment after the certain time-point, by using a plurality of pieces of training data, and one piece of training data includes a combination of at least a time series of two or more psychological state sensitivity expression words for learning of the plurality of psychological state sensitivity expression words for learning up to a time-point time(t) and non-fixed ambient environmental information for learning indicating a non-fixed ambient environment after the time-point time(t).

In order to solve the above problem, according to another aspect of the present invention, an estimation apparatus includes an estimation unit that estimates a non-fixed ambient environment of future by using an estimation model, which receives, as an input, at least a time series of two or more psychological state sensitivity expression words up to a certain time-point to estimate a non-fixed ambient environment, which is information related to a non-fixed ambient environment that is an ambient environment not uniquely defined for a location, after the certain time-point, based at least on the two or more psychological state sensitivity expression words that are input and an input order of the psychological state sensitivity expression words.

In order to solve the above problem, according to another aspect of the present invention, a learning apparatus includes a storage unit that stores at least psychological state sensitivity expression words for learning emitted by a plurality of persons in an identical location, time-points for learning when the psychological state sensitivity expression words for learning are emitted, and non-fixed ambient environmental information for learning, which is information related to a non-fixed ambient environment that is an ambient environment not uniquely defined for a location, when the psychological state sensitivity expression words for learning are emitted, and a learning unit that trains an estimation model, which receives, as inputs, at least a plurality of psychological state sensitivity expression words emitted by the plurality of persons in the identical location up to a certain time-point, and a time-point corresponding to each of the plurality of psychological state sensitivity expression words or an elapsed time from a predetermined time-point to estimate a non-fixed ambient environment after the certain time-point, by using a plurality of pieces of training data, and one piece of training data includes a combination of at least a plurality of psychological state sensitivity expression words for learning emitted by the plurality of persons in the identical location up to a time-point time(t), a time-point for learning corresponding to each of the plurality of psychological state sensitivity expression words for learning or an elapsed time from a predetermined time-point, and non-fixed ambient environmental information for learning indicating a non-fixed ambient environment after the time-point time(t).

In order to solve the above problem, according to another aspect of the present invention, an estimation apparatus includes an estimation unit that estimates a non-fixed ambient environment of future by using an estimation model, which receives, as inputs, at least a plurality of psychological state sensitivity expression words emitted by a plurality of persons in an identical location up to a certain time-point, and a time-point corresponding to each of the plurality of psychological state sensitivity expression words or an elapsed time from a predetermined time-point to estimate a non-fixed ambient environment, which is information related to a non-fixed ambient environment that is an ambient environment not uniquely defined for a location, after the certain time-point, based at least on the plurality of psychological state sensitivity expression words emitted by the plurality of persons in the identical location and the time-point corresponding to each of the plurality of psychological state sensitivity expression words or the elapsed time from the predetermined time-point.

### Effects of the Invention

According to the present invention, it is possible to exert the effects that a non-fixed ambient environment of the future can be estimated based on psychological state sensitivity expression words until now.

### BRIEF DESCRIPTION OF DRAWINGS

FIG. 1 is a diagram illustrating a configuration example of an estimation system according to a first embodiment.

FIG. 2 is a functional block diagram of a learning apparatus according to the first embodiment.

FIG. 3 is a diagram illustrating an example of a processing flow of a learning apparatus according to the first embodiment.

FIG. 4 is a diagram illustrating an example of data stored in a storage unit.

FIG. 5 is a diagram illustrating an estimation model.

FIG. 6 is a functional block diagram of an estimation apparatus according to the first embodiment.

FIG. 7 is a diagram illustrating an example of a processing flow of the estimation apparatus according to the first embodiment.

FIG. 8 is a diagram illustrating an example of data stored in a temporary storage unit.

FIG. 9 is a diagram illustrating a configuration example of a computer functioning as the learning apparatus and estimation apparatus.

### DESCRIPTION OF EMBODIMENTS

Hereinafter, embodiments of the present invention will be described. In the drawings used in the following description, the same reference signs are given to components having the same function or the steps of performing the same processing, and duplicate description is omitted. It is assumed that in the description below, processing performed for each element of a vector or a matrix is applied to all elements of the vector or the matrix unless otherwise specified.

### First Embodiment

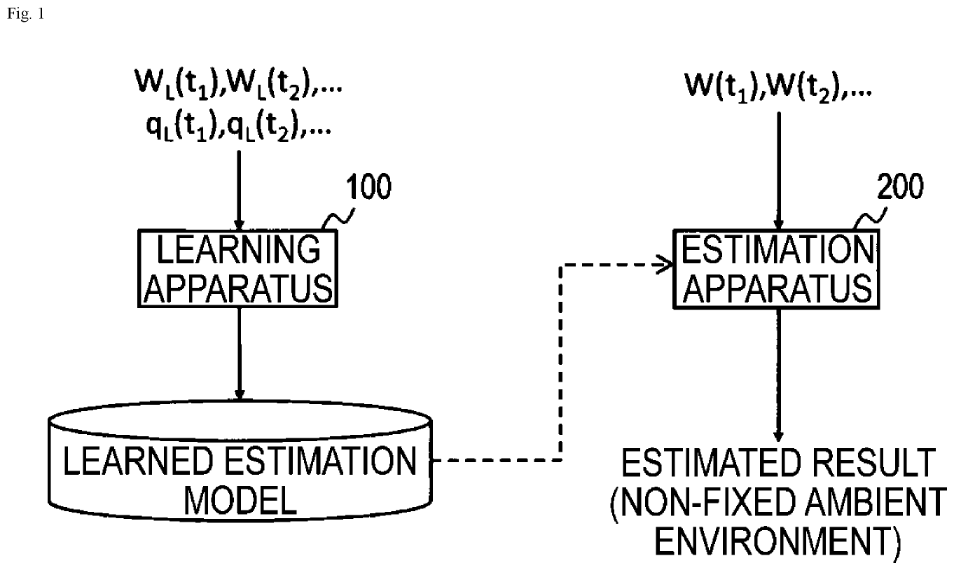

FIG. 1 illustrates a configuration example of an estimation system according to a first embodiment.

The estimation system according to the present embodiment includes a learning apparatus 100 and an estimation apparatus 200.

The learning apparatus 100 receives, as inputs, psychological state sensitivity expression words for learning W_{L}(t₁), W_{L}(t₂), . . . , and information related to a non-fixed ambient environment for learning (hereinafter, also referred to as “non-fixed ambient environmental information”) q_{L}(t₁), q_{L}(t₂), . . . , trains an estimation model, and outputs the learned estimation model.

The estimation apparatus 200 receives the learned estimation model output by the learning apparatus 100, prior to estimation. The estimation apparatus 200 receives, as an input, a time series of psychological state sensitivity expression words W(t₁), W(t₂), . . . for estimation, estimates a non-fixed ambient environment of the future by using the estimation model, and outputs an estimation result. Note that t₁, t₂, . . . are indices indicating an input order, and for example, W(tᵢ) refers to the i-th input psychological state sensitivity expression word.

In the present embodiment, a person is considered as a sensor, and a psychological state sensitivity expression word emitted by the person is used instead of a sensor output value, to estimate a non-fixed ambient environment of the future. The reason why a person is considered as a sensor is because a person has various sensations representative of five senses to consciously or unconsciously perceive a variety of ambient environments and changes thereof. Here, the psychological state sensitivity expression word represents a psychological state that is difficult to express logically or physically, and is a sensory or sensitive representation. Thus, it is considered that a psychological state sensitivity expression word emitted at a point in time may contain information having a relevance to an ambient environment at that point of time that is consciously or unconsciously perceived. In the present embodiment, a non-fixed ambient environment changes with time while having a relevance to a past state and a psychological state sensitivity expression word emitted at a point of time may contain information having a relevance to a non-fixed ambient environment at that point of time, and thus, these relevances are used to estimate a non-fixed ambient environment after at the certain time-point by use of a time series of psychological state sensitivity expression words input up to that certain time-point.

Each of the learning apparatus and the estimation apparatus is, for example, a special apparatus formed by loading a special program into a known or dedicated computer having a central processing unit (CPU), a main storage device (a random access memory (RAM)), and the like. Each of the learning apparatus and the estimation apparatus executes, for example, each process under the control of the CPU. Data input to each of the learning apparatus and the estimation apparatus and data obtained through each process are stored, for example, in the main storage device, and the data stored in the main storage device is read out to the central processing unit as needed and used for other processing. Each processing unit of the learning apparatus and the estimation apparatus may be at least partially configured by hardware such as an integrated circuit. Each storage unit included in the learning apparatus and the estimation apparatus can be configured, for example, by a main storage device such as a random access memory (RAM) or by middleware such as a relational database or a key-value store. However, each storage unit does not necessarily have to be provided inside the learning apparatus and the estimation apparatus and may be configured by a hard disk, an optical disc, or an auxiliary storage device formed from a semiconductor memory device such as a flash memory and may be provided outside the learning apparatus and the estimation apparatus.

First, the learning apparatus will be described.

Learning Apparatus 100

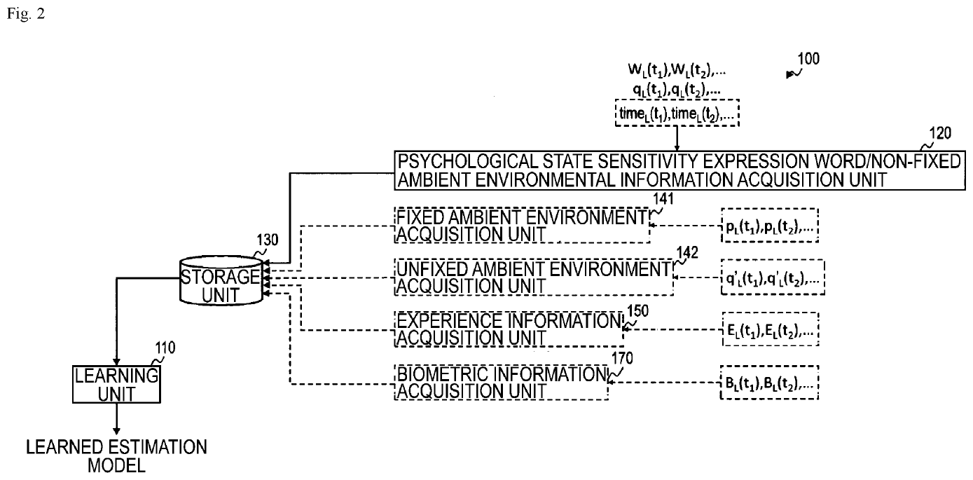

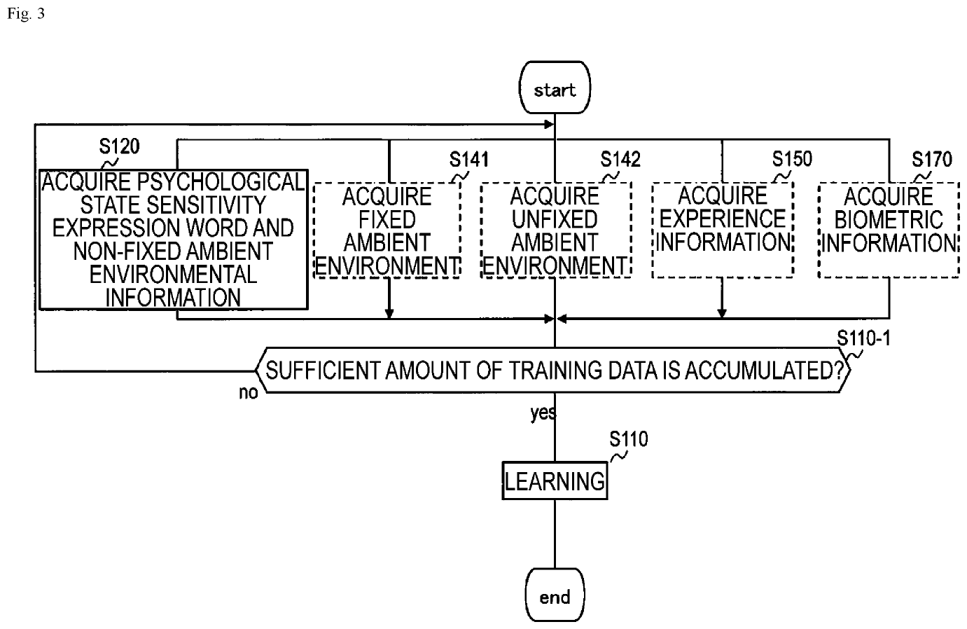

FIG. 2 illustrates a functional block diagram of the learning apparatus 100 according to the first embodiment, and FIG. 3 illustrates a processing flow thereof.

The learning apparatus 100 includes a learning unit 110, a psychological state sensitivity expression word/non-fixed ambient environmental information acquisition unit 120, and a storage unit 130.

Psychological State Sensitivity Expression Word/Non-Fixed Ambient Environmental Information Acquisition Unit 120 and Storage Unit 130

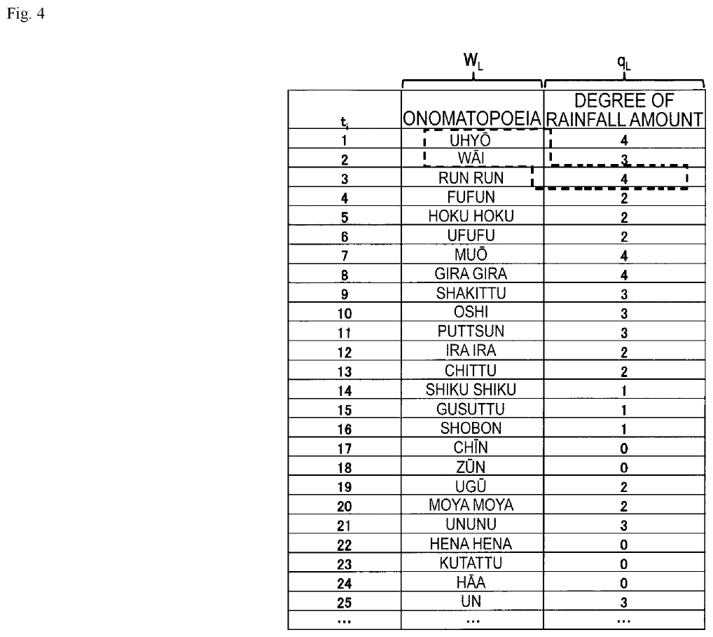

The psychological state sensitivity expression word/non-fixed ambient environmental information acquisition unit 120 accepts from a user (an object person from whom data is acquired) inputs of onomatopoeia character strings (psychological state sensitivity expression words for learning) W_{L}(t₁), W_{L}(t₂), . . . each representing a state of the user at a time of input and information related to a non-fixed ambient environment (non-fixed ambient environmental information for learning) q_{L}(t₁), q_{L}(t₂), . . . at that time (S120), and stores the input data in the storage unit 130. Thus, in the storage unit 130, the psychological state sensitivity expression words for learning W_{L}(t₁), W_{L}(t₂), . . . , and the non-fixed ambient environmental information for learning q_{L}(t₁), q_{L}(t₂), . . . are stored. FIG. 4 illustrates an example of data stored in the storage unit 130. Note that the data is stored in the order of input from the user (i.e., in a time-point order of input by the user). In other words, the data is stored in an order of acceptance by the psychological state sensitivity expression word/non-fixed ambient environmental information acquisition unit 120. In the example of FIG. 4, an index tᵢ indicating the order of input from the user (the acceptance order of the psychological state sensitivity expression word/non-fixed ambient environmental information acquisition unit 120) is stored together, but the index tᵢ may not be stored in a case that the order of input from the user (the acceptance order of the psychological state sensitivity expression word/non-fixed ambient environmental information acquisition unit 120) is known from a storage location or the like.

A non-fixed ambient environment represents a preset scale in a plurality of stages, such as the degree of a rainfall amount where a heavy rain state is defined as 4 and a no-rain state is defined as 0, for example. The number of non-fixed ambient environments may be one or multiple.

For example, an input field for the onomatopoeia character string and an input field for the non-fixed ambient environmental information are displayed on a display of a mobile terminal, a tablet terminal, or the like, to which the user inputs an onomatopoeia character string and non-fixed ambient environmental information via an input unit such as a touch panel.

Note that the input field may be configured such that a predetermined type of onomatopoeia character strings or non-fixed ambient environmental information represented in a plurality of preset stages are displayed and selected, or such that the user freely inputs.

A timing for inputting the data for learning may be configured such that a message is displayed, for example, via a display unit such as a touch panel every predetermined time to prompt a user to input an onomatopoeia character string and non-fixed ambient environmental information so that the user makes an input, based on the message, or such that a user opens at any timing an application accepting input of an onomatopoeia character string and non-fixed ambient environmental information to input.

For example, the data input may be configured such that the user inputs only an onomatopoeia character string and the psychological state sensitivity expression word/non-fixed ambient environmental information acquisition unit 120 accepts from the user (an object person from whom data is acquired) only the onomatopoeia character strings W_{L}(t₁), W_{L}(t₂), . . . each representing a state of the user at the time of the input. In this case, the psychological state sensitivity expression word/non-fixed ambient environmental information acquisition unit 120 may acquire the non-fixed ambient environmental information by using an acquisition means (not illustrated) corresponding to the non-fixed ambient environmental information. For example, the psychological state sensitivity expression word/non-fixed ambient environmental information acquisition unit 120 may include a GPS unit and an information collecting unit connected to the Internet. In this case, it is only required that the GPS unit acquire positional information when an input of a psychological state sensitivity expression word for learning is accepted, and the information collecting unit acquire non-fixed ambient environmental information corresponding to the positional information such as the weather information of rainfall amount, air temperature, humidity, and the like from a website of a meteorological observatory, for example. Alternatively, for example, the psychological state sensitivity expression word/non-fixed ambient environmental information acquisition unit 120 may include a sensor configured to acquire the weather information of air temperature, humidity, and the like, where the sensor may acquire non-fixed ambient environmental information such as the weather information.

Learning Unit 110

When the psychological state sensitivity expression words for learning an amount of which is sufficient for learning and the corresponding non-fixed ambient environmental information for learning are accumulated in the storage unit 130 (S110-1), the learning unit 110 retrieves psychological state sensitivity expression words for learning and corresponding non-fixed ambient environmental information for learning from the storage unit 130, trains an estimation model (S110), and outputs the learned estimation model.

Note that the estimation model is a model for receiving, as inputs, two or more psychological state sensitivity expression words up to a time-point time(t) in the time-point order to estimate a non-fixed ambient environment after the time-point time(t). Note that the time-point time(t) represents a time-point at which the t-th psychological state sensitivity expression word is input. In the present embodiment, an input time-point (acceptance time-point) is not acquired, but the input order (acceptance order) is identified, so it is possible to identify whether or not a psychological state sensitivity expression word is input up to the time-point time(t) at which the t-th psychological state sensitivity expression word is input and whether or not non-fixed ambient environment is of later than the time-point time(t).

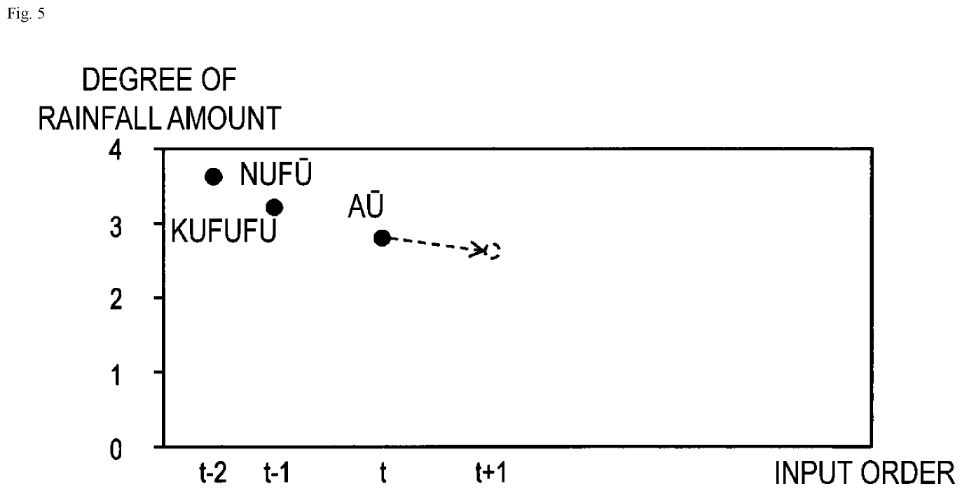

For example, the estimation model in the case of FIG. 5 is an estimation model for receiving, as inputs, the (t−1)-th psychological state sensitivity expression word W(t−1) “nufū” and the t-th psychological state sensitivity expression word W(t) “au” to estimate the (t+1)-th non-fixed ambient environmental information q(t+1). Thus, the learning apparatus 100 uses a large amount of training data to train the estimation model, where a set of training data includes a combination of two or more psychological state sensitivity expression words up to the time-point time(t) in time-point order and the non-fixed ambient environmental information for learning indicating the non-fixed ambient environment after time-point time(t) (e.g., a portion surrounded by dashed lines in FIG. 4).

Note that the estimation model according to the present embodiment is for receiving, as inputs, two or more psychological state sensitivity expression words up to the time-point time(t) in the order of time-points when those words were emitted by an object person, to estimate a non-fixed ambient environment of the object person after the time-point time(t). In a case that the psychological state sensitivity expression word/non-fixed ambient environmental information acquisition unit 120 acquires the psychological state sensitivity expression words and the non-fixed ambient environmental information from a plurality of users, the psychological state sensitivity expression words and non-fixed ambient environmental information acquired from each of the users are stored in the storage unit 130 together with an identifier for each user, and the learning is performed using the time series of psychological state sensitivity expression word and non-fixed ambient environmental information for each user during the learning. Note that “emitting” a psychological state sensitivity expression word means representing the psychological state sensitivity expression word externally by some means, and conceptually includes “inputting” the psychological state sensitivity expression word through the input unit such as a touch panel, “speaking” the psychological state sensitivity expression word, and the like. Note that the processing in the case of “speaking” the psychological state sensitivity expression word will be described later.

Note that the training data may be acquired from a single user. However, in a case that many and unspecified object persons are the estimation targets, it is desirable to acquire the training data from a plurality of users in order to be able to deal with the many and unspecified object persons and to acquire a sufficient amount of training data. That is, it is preferable to prepare a large number of combinations of the psychological state sensitivity expression words of the plurality of users and the non-fixed ambient environmental information when the psychological state sensitivity expression words are emitted to use the time series of psychological state sensitivity expression word and non-fixed ambient environmental information for each user as the training data. The estimation model learned using such training data is also referred to as a first estimation model. Furthermore, training data may be acquired from a new user that is an object person as the estimation target of the estimation apparatus 200 (an object person from whom data is acquired) and used to re-train the first estimation model, and the re-trained estimation model may be output as a model used for the estimation apparatus 200. With such a configuration, it is possible to acquire a sufficient amount of training data while training the estimation model taking into account the characteristics of the estimation target.

FIG. 4 illustrates an example of a table including the training data. In this example, the degrees of the rainfall amount are expressed as numerical values in five stages, with 4 as a heavy rain state and 0 as a no-rain state.

### Example 1 of Estimation Model

An estimation model (e.g., table or list) is used in which two or more onomatopoeias (character strings) up to a certain time-point in the time-point order are associated with non-fixed ambient environmental information after the time-point. Used as each piece of non-fixed ambient environmental information in the table or the list is, for example, a representative value (average value, median value, or the like) of the non-fixed ambient environmental information assigned by each person to a certain onomatopoeia in the training data.

### Example 2 of Estimation Model

In this example, the estimation model is a model trained by machine learning, such as a neural network, based on two or more onomatopoeias for learning up to a certain time-point in the time-point order and non-fixed ambient environmental information for learning after the time-point. For example, a neural network is used as the estimation model, into which two or more onomatopoeias (character strings) up to a certain time-point in the time-point order are input and from which non-fixed ambient environmental information after the time-point is output. In this case, a result of estimating the non-fixed ambient environmental information is obtained by inputting two or more onomatopoeias (character strings) up to a certain time-point in the time-point order in the training data into the neural network to which a suitable initial value is set in advance, and parameters for the neural network are repeatedly updated such that the obtained result approximates to the non-fixed ambient environmental information after the time-point in the training data, and thereby the estimation model is trained. Note that in a case of using the training data in which a plurality of pieces of non-fixed ambient environmental information (air temperature, humidity, rainfall amount, etc.) are input for one onomatopoeia, the output of the estimation model may also be trained as a list (set) of a plurality of pieces of non-fixed ambient environmental information.

In this way, the estimation model is trained. Next, the estimation apparatus will be described.

Estimation Apparatus 200

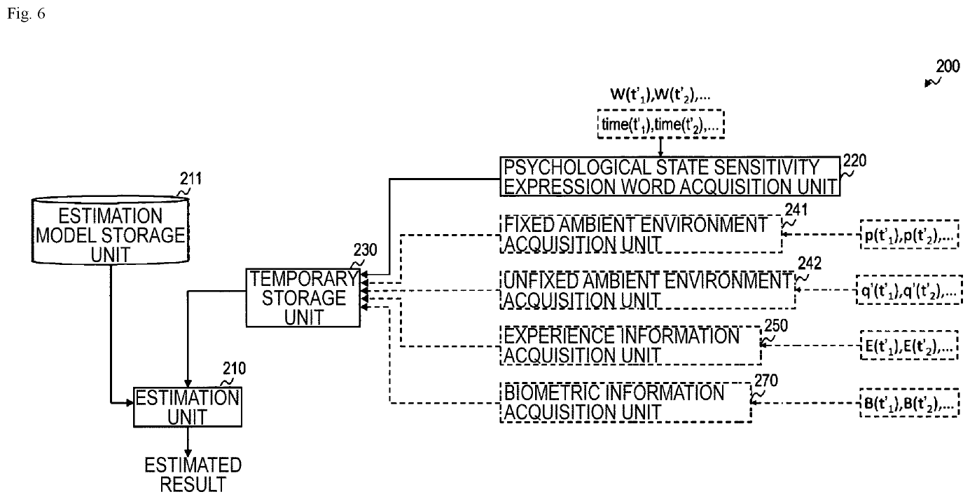

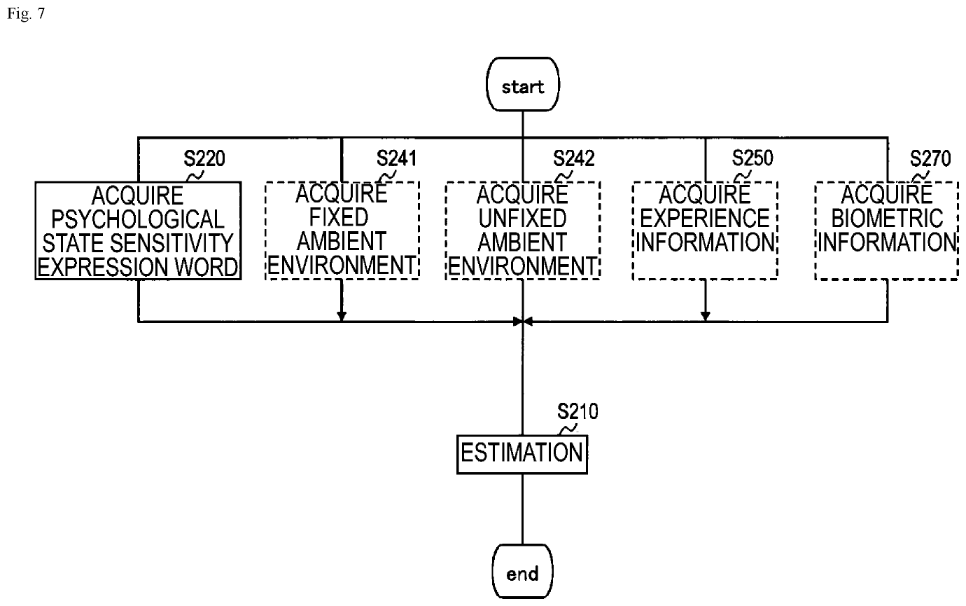

FIG. 6 illustrates a functional block diagram of the estimation apparatus 200 according to the first embodiment, and FIG. 7 illustrates a processing flow thereof.

The estimation apparatus 200 includes an estimation unit 210, an estimation model storage unit 211, a psychological state sensitivity expression word acquisition unit 220, and a temporary storage unit 230.

Psychological State Sensitivity Expression Word Acquisition Unit 220 and Temporary Storage Unit 230

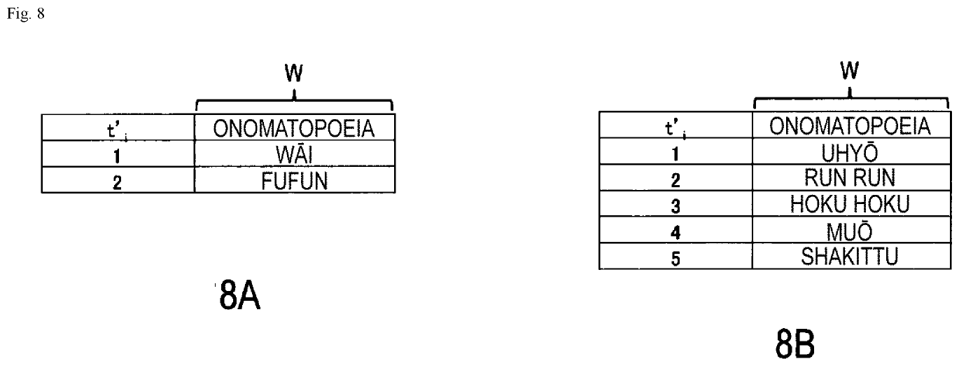

The psychological state sensitivity expression word acquisition unit 220 accepts from the user of the estimation apparatus 200 inputs of onomatopoeia character strings (psychological state sensitivity expression words) W(t′₁), W(t′₂), . . . expressing states of an object person at a plurality of time-points time(t′₁), time(t′₂), . . . (S220), and stores the onomatopoeia character strings in the temporary storage unit 230. Note that the user of the estimation apparatus 200 (who estimates the non-fixed ambient environment) and the object person (whose non-fixed ambient environment is estimated) may be the same person (the non-fixed ambient environment is estimated by oneself), or may be different persons. The temporary storage unit 230 stores the psychological state sensitivity expression words, and FIG. 8 illustrates an example of data stored in the temporary storage unit 230. FIG. 8A illustrates an example of a case that inputs of the psychological state sensitivity expression words W(t′₁) and W(t′₂) at two time-points are accepted, and FIG. 8B illustrates an example of a case that inputs of the psychological state sensitivity expression words W(t′₁), . . . , W(t′₅) at five time-points are accepted. Note that the data is stored in an order of input from the user, that is, in an order of acceptance by the psychological state sensitivity expression word acquisition unit 220. In the example of FIG. 8, an index t′ᵢ indicating the input order (acceptance order) is stored together, but the index t′ᵢ may not be stored in a case that the input order (acceptance order) is known from a storage location or the like.

Estimation Unit 210, Estimation Model Storage Unit 211

The estimation model storage unit 211 pre-stores the learned estimation model output by the learning apparatus 100. The estimation unit 210 retrieves two or more psychological state sensitivity expression words from the temporary storage unit 230 and uses the learned estimation model pre-stored in the estimation model storage unit 211 to estimate a non-fixed ambient environment of the future of the object person from two or more psychological state sensitivity expression words of the object person and the input order (acceptance order) thereof (S210), and outputs an estimated result. Note that it is only required that the estimation unit 210 retrieve, from the temporary storage unit 230, the psychological state sensitivity expression words required to estimate the non-fixed ambient environment of the future by using the estimation model, and the required psychological state sensitivity expression words are identified by a method of learning the estimation model.

In addition, the estimation unit 210 may be configured to use the required estimation model depending on the purpose of what kind of non-fixed ambient environmental information is desired to be estimated. For example, (i) a learned estimation model to estimate an “air temperature”, (ii) a learned estimation model to estimate a “rainfall amount”, (iii) a learned estimation model to estimate two kinds including an “air temperature” and a “rain amount”, and the like may be prepared and stored in the estimation model storage unit 211 so that the estimation unit 210 may select a required estimation model depending on the purpose.

Note that the estimation apparatus 200 may be any as long as receiving, as inputs, two or more psychological state sensitivity expression words up to the time-point time(t′) in the time-point order, and estimating the non-fixed ambient environment after the time-point time(t′), and the estimation model trained by the learning apparatus 100 and stored in the estimation model storage unit 211 of the estimation apparatus 200 may be any as long as being a model for receiving, as inputs, two or more psychological state sensitivity expression words up to the time-point time(t′) in the time-point order to estimate the non-fixed ambient environment after the time-point time(t′). For example, the number of the psychological state sensitivity expression words up to the time-point time(t′) in the time-point order used by the estimation apparatus 200 is not necessarily two but two or more, and the order of the emissions of those words by the object person is not necessarily continuous. Similarly, the number of the psychological state sensitive words up to the time-point time_{L}(t) in the time-point order used by the learning apparatus 100 is not necessarily two but two or more, and the order of the emission of those words by the user is not necessarily continuous. For example, the estimation apparatus 200 may use the (t′−3)-th, (t′−1)-th, and t′-th psychological state sensitivity expression words to estimate the non-fixed ambient environment after the time-point time(t′), and in this case, the estimation model to be trained by the learning apparatus 100 is a model that uses the (t−3)-th, (t−1)-th, and t-th psychological state sensitivity expression words to estimate a non-fixed ambient environment after the time-point time(t). Also, the non-fixed ambient environment estimated by the estimation apparatus 200 is a non-fixed ambient environment after the time-point time(t′) corresponding to the t′-th psychological state sensitivity expression word, and, for example, the estimation model learned by the learning apparatus 100 may be a model to estimate a non-fixed ambient environment corresponding to the (t+2)-th or subsequent psychological state sensitivity expression words. The estimation apparatus 200 may estimate two or more non-fixed ambient environments after the time-point time(t′), and in this case, the estimation model trained by the learning apparatus 100 is a model that estimates two or more non-fixed ambient environments after the time-point time(t). For example, the estimation apparatus 200 may use the (t′−1)-th and (t′−1)-th psychological state sensitivity expression words to estimate the (t′+1)-th and (t′+2)-th non-fixed ambient environments, and in this case, the estimation model to be trained by the learning apparatus 100 is a model that uses the (t−1)-th and t-th psychological state sensitivity expression words to estimate the (t+1)-th and (t+2)-th non-fixed ambient environments. These estimation models can be implemented depending on the learning, by configuring the input and output to and from the estimation model in consideration of the intended use, cost, and estimation accuracy of the estimation apparatus 200.

Effects

According to the configuration as described above, the non-fixed ambient environment of the future can be estimated, based on the psychological state sensitivity expression words until now.

### First Modification Example: Time

Parts different from the first embodiment will be mainly described.

In the present embodiment, a non-fixed ambient environment changes with time while having a relevance to a past state and a psychological state sensitivity expression word emitted at a point of time may contain information having a relevance to a non-fixed ambient environment at that point of time, and thus, these relevances are used to estimate a non-fixed ambient environment at a time-point after at a certain time-point by use of a time series of psychological state sensitivity expression words input up to that certain time-point accompanied by time information. In this modification example, an estimation model is trained by using, as inputs, time-points corresponding to two or more psychological state sensitivity expression words, and this estimation model obtained by the learning is used to estimate a non-fixed ambient environment of the future by using, as inputs, time-points corresponding to two or more psychological state sensitivity expression words.

Psychological State Sensitivity Expression Word/Non-Fixed Ambient Environmental Information Acquisition Unit 120, Storage Unit 130

The psychological state sensitivity expression word/non-fixed ambient environmental information acquisition unit 120 of the learning apparatus 100 accepts from the user inputs of onomatopoeia character strings (psychological state sensitivity expression words for learning) W_{L}(t₁), W_{L}(t₂), . . . each representing a state of the user at a time of input and information related to a non-fixed ambient environment (non-fixed ambient environmental information for learning) q_{L}(t₁), q_{L}(t₂), . . . at those times, acquires corresponding time-points time_{L}(t₁), time_{L}(t₂), . . . (S120), and stores combinations of these in the storage unit 130 (see FIG. 2). Note that because the input order is known from the corresponding time-points, the index tᵢ indicating the input order is not necessarily stored in the storage unit 130, but may be stored in the storage unit 130.

The corresponding time-point may be a time-point (input time-point) at which the user inputs the onomatopoeia character string and the non-fixed ambient environmental information via an input unit such as a touch panel, or a time-point (acceptance time-point) at which the psychological state sensitivity expression word/non-fixed ambient environmental information acquisition unit 120 accepts the onomatopoeia character string and the non-fixed ambient environmental information. In the case of the input time-point, the input unit such as a touch panel may be configured to acquire a time-point from a built-in clock, an NTP server, or the like to output the acquired time-point to the psychological state sensitivity expression word/non-fixed ambient environmental information acquisition unit 120, and in the case of the acceptance time-point, the psychological state sensitivity expression word/non-fixed ambient environmental information acquisition unit 120 may be configured to acquire an acceptance time-point from, for example, the built-in clock, the NTP server, or the like.

Note that the psychological state sensitivity expression word/non-fixed ambient environmental information acquisition unit 120 may be configured to display by a display unit such as a touch panel at predetermined time-points time_{L}(t₁), time_{L}(t₂), . . . , a message prompting to input an onomatopoeia character string and non-fixed ambient environmental information, and then, at each display time-point, accept inputs of an onomatopoeia character string W_{L}(t₁) and non-fixed ambient environmental information q_{L}(t₁) at that time, and store a combination of the onomatopoeia character string W_{L}(t₁), the non-fixed ambient environmental information q_{L}(t₁), and the corresponding time-point time_{L}(t₁) in the storage unit 130, accept inputs of an onomatopoeia character string W_{L}(t₂) and non-fixed ambient environmental information q_{L}(t₂) at that time, and store a combination of the onomatopoeia character string W_{L}(t₂), the non-fixed ambient environmental information q_{L}(t₂), and the corresponding time-point time_{L}(t₂) in the storage unit 130, . . . , and so on.

Learning Unit 110

When the psychological state sensitivity expression words for learning the amount of which is sufficient for learning, the corresponding non-fixed ambient environmental information for learning, and the corresponding time-points are accumulated in the storage unit 130 (S110-1), the learning unit 110 of the learning apparatus 100 retrieves psychological state sensitivity expression words for learning, time-points corresponding to the psychological state sensitivity expression words, and corresponding pieces of non-fixed ambient environmental information for learning from the storage unit 130, trains an estimation model (S110), and outputs the learned estimation model. Note that the corresponding time-points time_{L}(t₁), time_{L}(t₂), . . . may be used as they are to train an estimation model. Also, the time-points time_{L}(t₁), time_{L}(t₂), . . . may be used to determine an elapsed time from when a previous psychological state sensitivity expression word is emitted (for example, time_{L}(t₂)−time_{L}(t₁), time_{L}(t₃)−time_{L}(t₂), . . . ), and the elapsed time from when the previous psychological state sensitivity expression word is emitted is used to train an estimation model.

### Learning Example 1 of Estimation Model

For example, the learning apparatus 100 takes, as a set of training data, a combination of two or more psychological state sensitivity expression words W_{L}(t), W_{L}(t−1), . . . up to a certain time-point time_{L}(t), corresponding time-points time_{L}(t), time_{L}(t−1), . . . or time-point differences thereof (time_{L}(t)−time_{L}(t−1)), . . . , and non-fixed ambient environmental information q_{L}(t+1) after the time-point time_{L}(t), and uses a large amount of training data to train an estimation model.

The estimation model of learning example 1 in this modification example is a model that is, for the estimation apparatus 200, for receiving, as inputs, two or more psychological state sensitivity expression words up to the time-point time(t′) in the time-point order and time-points corresponding to those psychological state sensitivity expression words or time-point differences thereof, and is used to estimate a non-fixed ambient environment after the time-point time(t′).

### Learning Example 2 of Estimation Model

For example, the learning apparatus 100 takes, as a set of training data, a combination of two or more psychological state sensitivity expression words W_{L}(t), W_{L}(t−1), . . . up to a certain time-point time_{L}(t), an input order (acceptance order) t, t−1, . . . , time intervals |time_{L}(t)−time_{L}(t−1)|, . . . , and non-fixed ambient environmental information q_{L}(t+1) after the time-point time_{L}(t), and uses a large amount of training data to train an estimation model.

The estimation model of learning example 2 in this modification example is a model that is, for the estimation apparatus 200, for receiving, as inputs, two or more psychological state sensitivity expression words up to the time-point time(t′) in the time-point order, the input order (acceptance order) of those psychological state sensitivity expression words, and intervals of the time-points (time intervals) corresponding to those psychological state sensitivity expression words, and is used to estimate a non-fixed ambient environment after the time-point time(t′).

Psychological State Sensitivity Expression Word Acquisition Unit 220, Temporary Storage Unit 230

The psychological state sensitivity expression word acquisition unit 220 of the estimation apparatus 200 accepts inputs of onomatopoeia character strings (psychological state sensitivity expression words) W(t′¹), W(t′₂), . . . representing states of an object person at a plurality of time-points (S220), acquires corresponding time-points time(t′₁), time(t′₂), . . . , and stores combinations of these in the temporary storage unit 230. Thus, the temporary storage unit 230 stores time-points time(t′₁), time(t′₂), . . . corresponding to the psychological state sensitivity expression words. Note that because the input order (acceptance order) is known from the corresponding time-points, the index t′ᵢ indicating the input order (acceptance order) is not necessarily stored in the temporary storage unit 230, but the index t′ᵢ may be stored in the temporary storage unit 230. Note that a configuration for the psychological state sensitivity expression word acquisition unit 220 to acquire the time-point is similar to that of the psychological state sensitivity expression word/non-fixed ambient environmental information acquisition unit 120.

Estimation Unit 210, Estimation Model Storage Unit 211

The estimation model storage unit 211 pre-stores the learned estimation model output by the learning apparatus 100 of this modification example. The estimation unit 210 of the estimation apparatus 200 retrieves two or more psychological state sensitivity expression words and time-points corresponding to the psychological state sensitivity expression words from the temporary storage unit 230.

Estimation Example in Case of Using Estimation Model of Learning Example 1 Described Above

In a case of using the estimation model of learning example 1 in this modification example, the estimation unit 210 of the estimation apparatus 200 determines the time-point differences based on the corresponding time-points as necessary, and uses the learned estimation model of learning example 1 pre-stored in the estimation model storage unit 211 to estimate a non-fixed ambient environment of the future of the object person from two or more psychological state sensitivity expression words of the object persons and the time-points corresponding to the respective psychological state sensitivity expression words or time-point differences thereof (S210), and outputs an estimated result.

Estimation Example in Case of Using Estimation Model of Learning Example 2 Described Above

In a case of using the estimation model of learning example 2 in this modification example, the estimation unit 210 of the estimation apparatus 200 determines the input order (acceptance order) and the time intervals, based on the corresponding time-points, and uses the learned estimation model of learning example 2 pre-stored in the estimation model storage unit 211 to estimate a non-fixed ambient environment of the future of the object person from two or more psychological state sensitivity expression words of the object persons, the input order (acceptance order) of the respective psychological state sensitivity expression words, and the time intervals between the time-points corresponding to the psychological state sensitivity expression words corresponding to those psychological state sensitivity expression words (S210), and outputs an estimated result.

Note that in a case that the index t′ᵢ indicating the input order (acceptance order) is stored in the temporary storage unit 230, the index t′ᵢ indicating the input order (acceptance order) stored in the temporary storage unit 230 may be used as is without determining the input order (acceptance order) based on the time-points.

With the above configuration, similar advantageous effects to those of the first embodiment can be achieved. In addition, the non-fixed ambient environment can be more accurately estimated by taking the time-point into account.

### Second Modification Example: Plurality of Persons

Parts different from the first modification example will be mainly described.

A psychological state sensitivity expression word emitted by a person at a point of time may contain information having a relevance to a non-fixed ambient environment of the person at that point of time, but largely depends on a mood of the person at that point of time. Also, even in the same non-fixed ambient environment, the mood is different for each person. That is, it is assumed that learning and estimation performed using psychological state sensitivity expression words emitted by more persons in the same non-fixed ambient environment allow for learning and estimation that are less affected by moods of individual persons and have more relevances to the change with time in the non-fixed ambient environment. As such, in this modification example, the psychological state sensitivity expression words emitted by a plurality of object persons up to the time-point time(t) in the time-point order are used as inputs to estimate a non-fixed ambient environment after the time-point time(t). Note that the more the number of object persons, the better, in order to be less affected by the moods of individual persons and to have more relevances to the change with time in the non-fixed ambient environment. However, in a case that a non-fixed ambient environment that is to be the same if locations are the same (weather information, or the like) is to be estimated, the object persons are preferable in the same location (such as prefecture, city, within a several-kilometer radius, or the like).

Here, the mood is a “mood” meaning a state of emotion represented by “being energetic (vigorous)/not being energetic (vigorous)”, “pleasant/unpleasant”, “tense/relaxed”, “relieved/anxious”, “positive/negative”, “satisfying/unsatisfying”, “cool/irritative”, pleasure, sadness, anger, or the like. For example, even in the same non-fixed ambient environment, a large number of persons include a person who is energetic and a person who is not energetic, but by using the psychological state sensitivity expression words emitted by a large number of persons, the learning and estimation can be performed that have less relevances to whether or how the respective object persons are energetic and have higher relevances to the change with time in the non-fixed ambient environment.

It is assumed that if the number of persons who use the psychological state sensitivity expression words is large to some degree, the non-fixed ambient environment of the future can be estimated with being little affected by the individual moods. Thus, a large number here means that the number is large enough that the effect of the moods can be ignored.

Psychological State Sensitivity Expression Word/Non-Fixed Ambient Environmental Information Acquisition Unit 120, Storage Unit 130

The psychological state sensitivity expression word/non-fixed ambient environmental information acquisition unit 120 of the learning apparatus 100 accepts (S120) from a plurality of users inputs of onomatopoeia character strings (psychological state sensitivity expression words for learning) each representing a state of each user at a time of input and information related to non-fixed ambient environments (non-fixed ambient environmental information for learning), acquires corresponding time-points, and stores combinations of these in the storage unit 130 (see FIG. 2). The corresponding time-points may be acquired from an NTP server or the like because lags of the time-points between the users are preferably smaller. The combinations of the psychological state sensitivity expression word, the non-fixed ambient environmental information, and the time-point may be stored in the storage unit 130 without distinguishing between the inputting users, and when tᵢ is an index indicating the input order for all the users, for example, the combinations of the psychological state sensitivity expression word W_{L}(tᵢ), the non-fixed ambient environmental information q_{L}(tᵢ), and the time-point time_{L}(tᵢ) may be stored as {W_{L}(t₁), q_{L}(t₁), time_{L}(t₁)}, {W_{L}(t₂), q_{L}(t₂), time_{L}(t₂)}, . . . in the storage unit 130. In the case that a non-fixed ambient environment that is to be the same if locations are the same (weather information, or the like) is to be estimated, the psychological state sensitivity expression word/non-fixed ambient environmental information acquisition unit 120 may accept inputs of the psychological state sensitivity expression words and the non-fixed ambient environmental information from a plurality of users in a predetermined same location, or may store in the storage unit 130 the combinations of the psychological state sensitivity expression word, the non-fixed ambient environmental information, and the corresponding time-point of which input are accepted from a plurality of users in a predetermined same location among a plurality of users of which inputs are accepted. Note that the index tᵢ indicating the input order is not necessarily stored in the storage unit 130, but the index tᵢ may be stored in the storage unit 130. In the case of this modification example, inputs by a plurality of users at the same time-point may occur, but the index tᵢ itself is not technically meaningful, and thus, the index tᵢ for the order of the inputs at the same time-point may be in an order of storing in the storage unit 130.

Learning Unit 110

When the psychological state sensitivity expression words for learning the amount of which is sufficient for learning, the corresponding non-fixed ambient environmental information for learning, and the corresponding time-points are accumulated in the storage unit 130 (S110-1), the learning unit 110 of the learning apparatus 100 retrieves psychological state sensitivity expression words for learning, time-points corresponding to the psychological state sensitivity expression words, and corresponding pieces of non-fixed ambient environmental information for learning from the storage unit 130, trains an estimation model (S110), and outputs the learned estimation model. Note that the corresponding time-points time_{L}(t₁), time_{L}(t₂), . . . may be used as they are to train an estimation model. The time-points time_{L}(t₁), time_{L}(t₂), . . . may be used to determine an elapsed time from a predetermined time-point time_{L}(t₀) (for example, time_{L}(t₁)−time_{L}(t₀), time_{L}(t₂)−time_{L}(t₀), time_{L}(t₃)−time_{L}(t₀), . . . ), and the elapsed time from the predetermined time-point is used to train an estimation model.

### Learning Example of Estimation Model

For example, the learning apparatus 100 takes, as a set of training data, a combination of psychological state sensitivity expression words W_{L}(t), W_{L}(t−1), . . . emitted by a plurality of users up to a certain time-point time_{L}(t), corresponding time-points time_{L}(t), time_{L}(t−1), . . . or elapsed times from a predetermined time-point (time_{L}(t)−time_{L}(t₀)), (time_{L}(t−1)−time_{L}(t₀)), . . . , and non-fixed ambient environmental information q_{L}(t+1) after the time-point time_{L}(t), and uses a large amount of training data to train an estimation model.

The estimation model of a learning example in this modification example is a model that is, for the estimation apparatus 200, for receiving, as inputs, psychological state sensitivity expression words emitted by a plurality of object persons up to the time-point time(t′) corresponding to the respective psychological state sensitivity expression words and time-points or elapsed times from a predetermined time-point, and is used to estimate a non-fixed ambient environment after the time-point time(t′).

Estimation Unit 210, Estimation Model Storage Unit 211

The estimation model storage unit 211 pre-stores the learned estimation model output by the learning apparatus 100 of this modification example. The estimation unit 210 of the estimation apparatus 200 retrieves a large number of psychological state sensitivity expression words and time-points corresponding to the psychological state sensitivity expression words from the temporary storage unit 230.

Estimation Example in Case of Using Estimation Model of Learning Example Described Above

In a case of using the estimation model of the learning example in this modification example, the estimation unit 210 of the estimation apparatus 200 determines elapsed times from a predetermined time-point, based on the corresponding time-points as necessary, and uses the learned estimation model of the learning example pre-stored in the estimation model storage unit 211 to estimate a non-fixed ambient environment of the future of the object person from a large number of psychological state sensitivity expression words emitted by a large number of object persons and the time-points corresponding to the respective psychological state sensitivity expression words or elapsed times from a predetermined time-point (S210), and outputs an estimated result.

### Third Modification Example: Time-Point

Parts different from the first modification example will be mainly described.

This modification example uses also a time-point corresponding to the non-fixed ambient environment to train an estimation model, and use the learned estimation model to estimate how much later the estimated non-fixed ambient environment of the future is and estimate a non-fixed ambient environment at a specified future time-point.

Learning Unit 110

When the psychological state sensitivity expression words for learning an amount of which is sufficient for learning, the corresponding non-fixed ambient environmental information for learning, and the corresponding time-points are accumulated in the storage unit 130 (S110-1), the learning unit 110 of the learning apparatus 100 retrieves a psychological state sensitivity expression word for learning, a non-fixed ambient environmental information for learning corresponding to the psychological state sensitivity expression word for learning, and a time-point corresponding to the psychological state sensitivity expression word for learning and a time-point corresponding to the non-fixed ambient environmental information for learning from the storage unit 130, trains an estimation model (S110), and outputs the learned estimation model. For example, the learning apparatus 100 takes, as a set of training data, a combination of two or more psychological state sensitivity expression words up to a time-point time_{L}(t), a non-fixed ambient environmental information at a time-point time_{L}(t+1) that is after the time-point time_{L}(t), and time-point time_{L}(t) and the time-point time_{L}(t+1) or a time-point difference thereof time_{L}(t+1)−time_{L}(t), and uses a large amount of training data to train an estimation model.

Note that, the estimation model of this modification example is a model that is, for the estimation apparatus 200, for receiving, as inputs, two or more psychological state sensitivity expression words up to a time-point time(t′) in the time-point order, and is used to estimate a non-fixed ambient environment after the time-point time(t′) and a time-point corresponding to a non-fixed ambient environment after that non-fixed ambient environment after the time-point time(t′), or is a model that is, for the estimation apparatus 200, for receiving, as inputs, two or more psychological state sensitivity expression words up to a time-point time(t′) and a future time-point in the time-point order, and is used to estimate a non-fixed ambient environment at a future time-point.

Estimation Unit 210, Estimation Model Storage Unit 211

The estimation model storage unit 211 pre-stores the learned estimation model output by the learning apparatus 100 of this modification example. The estimation unit 210 of the estimation apparatus 200 retrieves two or more psychological state sensitivity expression words W(t′), W(t′−1), . . . and a corresponding time-point time(t′) from the temporary storage unit 230 and uses the learned estimation model pre-stored in the estimation model storage unit 211 to estimate a non-fixed ambient environment of the future of the object person and a time-point corresponding to the non-fixed ambient environment from two or more psychological state sensitivity expression words of the object person (S210), and outputs an estimated result. That is, how far future the non-fixed ambient environment is for is output in conjunction with the estimated result of the non-fixed ambient environment. Alternatively, the estimation unit 210 may include input means (not illustrated) to accept an input of a future time-point, that is, accept a specification of how far future an estimated result of a non-fixed ambient environment to be obtained is for, such that the user of the estimation apparatus 200 may specify that how far future an estimated result of a non-fixed ambient environment the estimation apparatus 200 is to obtain is for and the estimation unit 210 may estimate the non-fixed ambient environment of the future matching the specified content.

With the above configuration, similar advantageous effects to those of the first embodiment can be achieved. Further, how far future the non-fixed ambient environment is for can be considered from the time-point time(t′) corresponding to the psychological state sensitivity expression word W(t′).

Combination of First Modification Example and Third Modification Example Note that the first modification example and the third modification example may be combined. The estimation model of the combination of the first modification example and the third modification example is, for example, a model as follows.

### Combination Example 1

The estimation model is a model that is for receiving, as inputs, two or more psychological state sensitivity expression words up to the time-point time(t′) in the time-point order and time-points corresponding to those psychological state sensitivity expression words or time differences thereof to estimate a non-fixed ambient environment after the time-point time(t′) and a time-point corresponding to a non-fixed ambient environment after that non-fixed ambient environment after the time-point time(t′).

### Combination Example 2

The estimation model is a model that is for receiving, as inputs, two or more psychological state sensitivity expression words up to the time-point time(t′) in the time-point order, time-points corresponding to those psychological state sensitivity expression words or time differences thereof, and a future time-point to estimate a non-fixed ambient environment at a future time-point.

### Combination Example 3

The estimation model is a model that is for receiving, as inputs, two or more psychological state sensitivity expression words up to the time-point time(t′) in the time-point order, the input order (acceptance order) of those psychological state sensitivity expression words, and intervals of the time-points (time intervals) corresponding to those psychological state sensitivity expression words to estimate a non-fixed ambient environment after the time-point time(t′) and a time-point corresponding to a non-fixed ambient environment after that non-fixed ambient environment after the time-point time(t′).

### Combination Example 4

The estimation model is a model that is for receiving, as inputs, two or more psychological state sensitivity expression words up to the time-point time(t′) in the time-point order, the input order (acceptance order) of those psychological state sensitivity expression words, intervals of the time-points (time intervals) corresponding to those psychological state sensitivity expression words, and a future time-point to estimate a non-fixed ambient environment at the future time-point.

The estimation apparatus 200 of the combination of the first modification example and the third modification example pre-stores any estimation model among the above in the estimation model storage unit 211, and the estimation unit 210 obtains and outputs as an estimated result the non-fixed ambient environment of the future of the object person and the time-point corresponding to the non-fixed ambient environment, or the non-fixed ambient environment of the object person at the specified future time-point.

Combination of Second Modification Example and Third Modification Example

Note that the second modification example and the third modification example may be combined. The estimation model of the combination of the second modification example and the third modification example is, for example, a model as follows.

### Combination Example 1

The estimation model is a model that is for receiving, as inputs, psychological state sensitivity expression words emitted by a plurality of object persons up to the time-point time(t′) and time-points corresponding to the respective psychological state sensitivity expression words or elapsed times from a predetermined time-point to estimate a non-fixed ambient environment after the time-point time(t′) and a time-point corresponding to a non-fixed ambient environment after that non-fixed ambient environment after the time-point time(t′).

### Combination Example 2

The estimation model is a model that is for receiving, as inputs, psychological state sensitivity expression words emitted by a plurality of object persons up to the time-point time(t′), time-points corresponding to the respective psychological state sensitivity expression words or elapsed times from a predetermined time-point, and a future time-point to estimate a non-fixed ambient environment at a future time-point.

The estimation apparatus 200 of the combination of the second modification example and the third modification example pre-stores any estimation model among the above in the estimation model storage unit 211, and the estimation unit 210 obtains and outputs as an estimated result the non-fixed ambient environment of the future and the time-point corresponding to the non-fixed ambient environment, or the non-fixed ambient environment at the specified future time-point.

### Fourth Modification Example: Another Information

In addition to two or more psychological state sensitivity expression words up to a certain time-point, another piece of information up to a certain time-point can be taken into account to increase the estimation accuracy for the non-fixed ambient environment after the certain time-point. For example, examples of another piece of information are considered to include fixed ambient environmental information, unfixed ambient environmental information, experience information, biometric information, and other information affecting a mood. These pieces of information in addition to two or more psychological state sensitivity expression words and the non-fixed ambient environmental information are given to train an estimation model, and this estimation model obtained by the learning is used to estimate a non-fixed ambient environment with two or more psychological state sensitivity expression words being given these pieces of information.

Learning Apparatus 100

The learning apparatus 100 includes the learning unit 110, the psychological state sensitivity expression word/non-fixed ambient environmental information acquisition unit 120, and the storage unit 130, and in addition thereto, at least any of a fixed ambient environment acquisition unit 141, an unfixed ambient environment acquisition unit 142, an experience information acquisition unit 150, and a biometric information acquisition unit 170 (see FIG. 2).

Estimation Apparatus 200

The estimation apparatus 200 includes the estimation unit 210, the psychological state sensitivity expression word acquisition unit 220, and the temporary storage unit 230, and in addition thereto, at least any of a fixed ambient environment acquisition unit 241, an unfixed ambient environment acquisition unit 242, an experience information acquisition unit 250, and a biometric information acquisition unit 270 (see FIG. 6).

Fixed Ambient Environment Acquisition Units 141, 241

The fixed ambient environment acquisition unit 141 acquires information p_{L}(t) related to a fixed ambient environment (S141), and stores the information in the storage unit 130.

Similarly, the fixed ambient environment acquisition unit 241 acquires information p(t′) related to fixed ambient environment (S241), and stores the information in the temporary storage unit 230.

Note that, as described above, the “fixed ambient environment” is an ambient environment around an object person, and is an environment uniquely determined for a location and not changing in response to a change in time.

For example, an estimation model is trained so that an effect of a fixed ambient environment on a mood is also to be coped with, and the estimation model obtained by this learning is used to estimate a non-fixed ambient environment. For example, based on onomatopoeias input before and after entering a certain facility and information related to two fixed ambient environments indicating whether being within the facility, a subsequent non-fixed ambient environment is estimated.

For example, each of the fixed ambient environment acquisition units 141 and 241 is provided with a GPS function and a database in which positional information is associated with a fixed ambient environment, and obtains positional information by the GPS function and acquires information related to a fixed ambient environment associated with the positional information from the database. In addition, similar to the psychological state sensitivity expression word/non-fixed ambient environmental information acquisition unit 120 and the psychological state sensitivity expression word acquisition unit 220, the user of the learning apparatus 100 and the user of the estimation apparatus 200 may make inputs.

Unfixed Ambient Environment Acquisition Units 142, 242

The unfixed ambient environment acquisition unit 142 acquires information q′_{L}(t₁), q′_{L}(t₂), . . . related to unfixed ambient environments (unfixed ambient environmental information for learning) (S142), and stores the information in the storage unit 130. Note that the unfixed ambient environmental information q′ is non-fixed ambient environmental information different from the non-fixed ambient environmental information q. For example, in a case that the non-fixed ambient environmental information q is the rainfall amount, the unfixed ambient environmental information q′ may be the air temperature, or the like.

Similarly, the unfixed ambient environment acquisition unit 242 acquires information q′(t′) related to an unfixed ambient environment (unfixed ambient environmental information) (S242), and stores the information in the temporary storage unit 230.

An estimation model is trained so that an effect of an unfixed ambient environment on a mood is also to be coped with, and the estimation model obtained by this learning is used to estimate a non-fixed ambient environment. For example, based on onomatopoeias input before and after a change in the air temperature and information related to two unfixed ambient environments indicating the air temperature, a subsequent non-fixed ambient environment (rainfall amount or the like) is estimated.

For example, each of the unfixed ambient environment acquisition units 142 and 242 may include a sensor for acquiring an air temperature to acquire an air temperature. In addition, similar to the psychological state sensitivity expression word/unfixed ambient environmental information acquisition unit 120 and the psychological state sensitivity expression word acquisition unit 220, the user of the learning apparatus 100 and the user of the estimation apparatus 200 may make inputs.

Experience Information Acquisition Units 150, 250

The experience information acquisition unit 150 acquires experience information E_{L}(t) related to an experience of a user (S150), and stores the information in the storage unit 130.

Similarly, the experience information acquisition unit 250 acquires information E(t′) related to an experience of an object person (S250), and stores the information in the temporary storage unit 230.

For example, examples of the experience information are considered to include information indicating having or not having an experience of eating a certain food, an experience of hearing a certain music, an experience of playing a certain game, and the like. For example, an estimation model is trained so that an effect of experience information on a mood is also to be coped with, and the estimation model obtained by this learning is used to estimate a non-fixed ambient environment. For example, based on onomatopoeias input before and after a music live concert and two pieces of experience information indicating having or not having an experience of a live concert, a subsequent non-fixed ambient environment is estimated.

For example, each of the experience information acquisition units 150 and 250 is provided with a GPS function and a database in which positional information is associated with a facility offering a predetermined experience (restaurant, live concert venue, attraction facility, or the like), and obtains positional information by the GPS function and acquires information indicating a predetermined experience offered by a facility associated with the positional information from the database. In addition, similar to the psychological state sensitivity expression word/non-fixed ambient environmental information acquisition unit 120 and the psychological state sensitivity expression word acquisition unit 220, the user of the learning apparatus 100 and the user of the estimation apparatus 200 may make inputs.

Biometric Information Acquisition Units 170, 270

The biometric information acquisition unit 170 acquires biometric information B_{L}(t) of a user (S170), and stores the information in the storage unit 130.

Similarly, the biometric information acquisition unit 270 acquires biometric information B(t′) of an object person (S270), and stores the information in the temporary storage unit 230.

For example, examples of the biometric information are considered to include information indicating heartbeat, respiration, facial expression, and the like. For example, an estimation model is trained so that an effect of biometric information on a mood is also to be coped with to estimate a non-fixed ambient environment. For example, based on a change in the heartbeat or the respiration, a non-fixed ambient environment is estimated. The onomatopoeia such as “doki doki” is obtained, and as such, in a case that there is a change or no change in the heartbeat or the respiration, how the non-fixed ambient environment at the time-point time(t+1) is affected is learned, and so on to estimate a non-fixed ambient environment.

For example, each of the biometric information acquisition units 170 and 270 is provided with a function to acquire biometric information, and acquires biometric information. Each of the biometric information acquisition units 170 and 270 is provided with, for example, an application corresponding to a wearable device such as a hitoe (trade name), and acquires biometric information of the object person.

Learning Unit 110

When the psychological state sensitivity expression words for learning the amount of which is sufficient for learning, the corresponding non-fixed ambient environmental information for learning, and the following items (i) to (iv) are accumulated in the storage unit 130 (S110-1), the learning unit 110 retrieves psychological state sensitivity expression words for learning, corresponding pieces of non-fixed ambient environmental information for learning, and the items (i) to (iv) from the storage unit 130, trains an estimation model (S110), and outputs the learned estimation model.
(i) Information related to a fixed ambient environment of an inputting person at a time of inputting a psychological state sensitivity expression word, the fixed ambient environment being uniquely determined for a location.
(ii) Information related to an ambient environment of an inputting person at a time of inputting a psychological state sensitivity expression word, the ambient environment not being uniquely defined for a location, i.e., the ambient environment changing in response to a change in time, excluding the non-fixed ambient environmental information.
(iii) Experience information related to an experience of an inputting person at a time of inputting a psychological state sensitivity expression word.
(iv) Biometric information of an inputting person at a time of inputting a psychological state sensitivity expression word.

Note that it is not necessary to use all of (i) to (iv) for learning, and information required for estimation may be acquired and stored to perform learning, based on the acquired information. A time series of at least one or more of (i) to (iv) may be used.

The estimation model in this modification example is a model that is, for the estimation apparatus 200, for receiving, as inputs, two or more psychological state sensitivity expression words up to the time-point time(t′) in the time-point order and a time series of at least one or more of (i) to (iv) above corresponding to the psychological state sensitivity expression words, and is used to estimate a non-fixed ambient environment after the time-point time(t′).

Estimation Unit 210, Estimation Model Storage Unit 211

The estimation model storage unit 211 pre-stores the learned estimation model output by the learning apparatus 100 of this modification example. The estimation unit 210 retrieves two or more psychological state sensitivity expression words and at least one or more of (i) to (iv) above used for learning by the learning unit 110 from the temporary storage unit 230 and uses the learned estimation model pre-stored in the estimation model storage unit 211 to estimate (S210) a non-fixed ambient environment of the future from two or more psychological state sensitivity expression words and the at least one or more of (i) to (iv), and outputs an estimated result.

Effects

With the above configuration, similar advantageous effects to those of the first embodiment can be achieved. Furthermore, the non-fixed ambient environment can be more accurately estimated by taking at least one or more of (i) to (iv) into account. Note that this modification example and the first to third modification examples may be combined.

Note that in this modification example, the description is given assuming that the timings for acquiring the respective pieces of information by the fixed ambient environment acquisition unit, the unfixed ambient environment acquisition unit, the experience information acquisition unit, and the biometric information acquisition unit are the same as the timings for acquiring the psychological state sensitivity expression words by the psychological state sensitivity expression word/non-fixed ambient environmental information acquisition unit and the psychological state sensitivity expression word acquisition unit, but those timings may be different for each acquisition unit. Each piece of information at the timing closest to the timing for acquiring the psychological state sensitivity expression word may be used, or insufficient information may be supplemented, or excessive information may be subtracted.

### Fifth Modification Example

The first embodiment describes that the user of the learning apparatus 100 and the user of the estimation apparatus 200 input onomatopoeia character strings, but the configuration is not limited to inputting the character string itself.

For example, an illustration, an image, or the like that has a one-to-one association with an onomatopoeia may be input. In this case, a database in which the onomatopoeia is associated with the illustration, the image, or the like may be provided such that the illustration, the image, or the like is input and the corresponding onomatopoeia character string is retrieved from the database.

For example, the onomatopoeia character string included in a result of speech recognition of a speech of the object person may be automatically extracted to accept input of the onomatopoeia character string. For example, instead of an onomatopoeia character string, a speech signal may be input, on which speech signal speech recognition processing is performed by a speech recognition unit (not illustrated) to obtain a speech recognition result from which an onomatopoeia character string is extracted and output. For example, a database storing an onomatopoeia character string of interest may be provided, and by referring to the database, an onomatopoeia character string is extracted from the speech recognition result.

In addition, in an estimation phase, for example, an onomatopoeia character string to be used as input may be automatically extracted from a text string input when the object person creates an e-mail or creates a comment posted to the web, or may be automatically extracted from a result of speech recognition of a voice of the object person when the object person talks on a mobile phone or the like.

Furthermore, in a learning phase, a time series (a text string input in creating an e-mail or creating a comment posted to the web, a speech recognition result) emitted from the same person, regardless of whether that person is the object person, where both an onomatopoeia and a non-fixed ambient environment word appear in a time series manner, can be used for learning.

Note that this modification example and the first to fourth modification examples may be combined.

### Other Modification Examples

The present invention is not limited to the above-described embodiments and modification examples, and appropriate changes can be made without departing from the gist of the present invention.

Program and Recording Medium

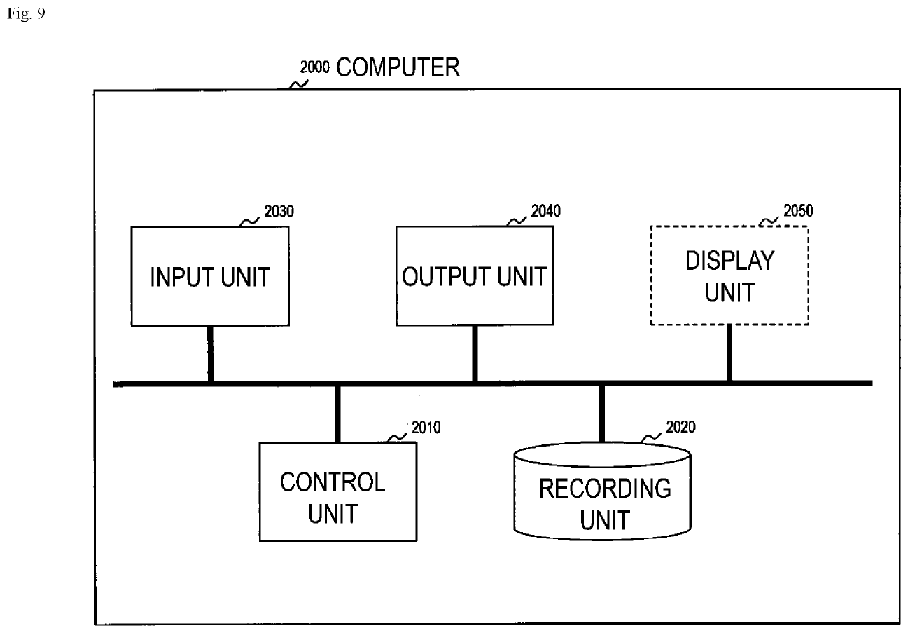

The various types of processing described above can be performed by causing a recording unit 2020 of a computer illustrated in FIG. 9 to read a program for executing each of steps of the above method and causing a control unit 2010, an input unit 2030, an output unit 2040, and the like to execute the program.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network so that the program is distributed.

For example, a computer executing the program first temporarily stores the program recorded on the portable recording medium or the program transmitted from the server computer in its own storage device. When the computer executes the process, the computer reads the program stored in the recording medium of the computer and executes a process according to the read program. Further, as another execution mode of this program, the computer may directly read the program from the portable recording medium and execute processing in accordance with the program, or, further, may sequentially execute the processing in accordance with the received program each time the program is transferred from the server computer to the computer. In addition, another configuration to execute the processing through a so-called application service provider (ASP) service in which processing functions are implemented just by issuing an instruction to execute the program and obtaining results without transmitting the program from the server computer to the computer may be employed. Further, the program in this mode is assumed to include information which is provided for processing of a computer and is equivalent to a program (data or the like that has characteristics of regulating processing of the computer rather than being a direct instruction to the computer).

In addition, although the device is configured to execute a predetermined program on a computer in this mode, at least a part of the processing details may be implemented by hardware.

1. A learning apparatus comprising a circuit configured to execute a method comprising:
storing at least a plurality of psychological state sensitivity expression words for learning and non-fixed ambient environmental information for learning when a psychological state sensitivity expression word for learning of the plurality of psychological state sensitivity expression words for learning is emitted, the non-fixed ambient environmental information for learning being information related to a non-fixed ambient environment that is an ambient environment not uniquely defined for a location; and
training an estimation model by using a plurality of pieces of training data, one piece of training data including a combination of at least a time series of two or more psychological state sensitivity expression words for learning of the plurality of psychological state sensitivity expression words for learning up to a time-point time and the non-fixed ambient environmental information for learning indicating a non-fixed ambient environment after the time-point time, the estimation model being for receiving, as an input, at least a time series of two or more psychological state sensitivity expression words of the plurality of psychological state sensitivity expression words for learning up to a certain time-point to estimate a non-fixed ambient environment after the certain time-point.

2. An estimation apparatus comprising a circuit configured to execute a method comprising:
estimating a non-fixed ambient environment of future by using an estimation model, the estimation model being for receiving, as an input, at least a time series of two or more psychological state sensitivity expression words up to a certain time-point to estimate a non-fixed ambient environment after the certain time-point, the non-fixed ambient environment being information related to a non-fixed ambient environment that is an ambient environment not uniquely defined for a location, based at least on the two or more psychological state sensitivity expression words that are input and an input order of the psychological state sensitivity expression words.

3-4. (canceled)

5. The estimation apparatus according to claim 2, wherein
the estimation model represents a model for receiving, as an input, at least one of:
information about a fixed ambient environment that is uniquely defined for a location,
unfixed ambient environmental information associated with an ambient environment that is not uniquely defined for a location, the unfixed ambient environmental information being different from information associated with the non-fixed ambient environment,
experience information related to an experience, or
biometric information to estimate the non-fixed ambient environment after the certain time-point, and
the estimation model estimates a non-fixed ambient environment of future of an inputting person, based on at least one of:
information related to a fixed ambient environment of the inputting person at a time of inputting a psychological state sensitivity expression word, that is uniquely defined for a location,
unfixed ambient environmental information associated with an ambient environment of the inputting person at the time of inputting the psychological state sensitivity expression word, that is not uniquely defined for a location, the unfixed ambient environmental information being different from the information associated with non-fixed ambient environment,
experience information related to an experience of the inputting person at the time of inputting the psychological state sensitivity expression word, or
biometric information of the inputting person at the time of inputting the psychological state sensitivity expression word.

6. A learning method for storing at least a plurality of psychological state sensitivity expression words for learning and non-fixed ambient environmental information for learning when a psychological state sensitivity expression word for learning of the plurality of psychological state sensitivity expression words for learning is emitted, the non-fixed ambient environmental information for learning being information related to a non-fixed ambient environment that is an ambient environment not uniquely defined for a location, the learning method comprising
training an estimation model by using a plurality of pieces of training data, one piece of training data including a combination of at least a time series of two or more psychological state sensitivity expression words for learning of the plurality of psychological state sensitivity expression words for learning up to a time-point time and the non-fixed ambient environmental information for learning indicating a non-fixed ambient environment after the time-point time, the estimation model being for receiving, as an input, at least a time series of two or more psychological state sensitivity expression words of the plurality of psychological state sensitivity expression words for learning up to a certain time-point to estimate a non-fixed ambient environment after the certain time-point.

7-10. (canceled)

11. The learning apparatus according to claim 1, wherein the non-fixed ambient environment includes an ambient environment changing over time.

12. The learning apparatus according to claim 1, wherein the non-fixed ambient environment includes an ambient environment changing over time at a location.

13. The learning apparatus according to claim 1, wherein the non-fixed ambient environment includes weather information.

14. The learning apparatus according to claim 1, wherein the plurality of psychological state sensitivity expression words include an onomatopoeic word.

15. The learning apparatus according to claim 1, wherein the plurality of psychological state sensitivity expression words include exclamation.

16. The learning apparatus according to claim 1, wherein the estimation model includes a neural network for receiving the two or more two or more psychological state sensitivity expression words up to the certain time-point in the time-point order and for outputting the non-fixed ambient environmental information after the time-point.

17. The estimation apparatus according to claim 2, wherein the non-fixed ambient environment includes an ambient environment changing over time.

18. The estimation apparatus according to claim 2, wherein the non-fixed ambient environment includes an ambient environment changing over time at a location.

19. The estimation apparatus according to claim 2, wherein the non-fixed ambient environment includes weather information.

20. The estimation apparatus according to claim 2, wherein the plurality of psychological state sensitivity expression words include an onomatopoeic word.

21. The estimation apparatus according to claim 2, wherein the estimation model includes a neural network for receiving the two or more two or more psychological state sensitivity expression words up to the certain time-point in the time-point order and for outputting non-fixed ambient environmental information after the time-point.

22. The learning method according to claim 6, wherein the non-fixed ambient environment includes an ambient environment changing over time.

23. The learning method according to claim 6, wherein the non-fixed ambient environment includes an ambient environment changing over time at a location.

24. The learning method according to claim 6, wherein the non-fixed ambient environment includes weather information.

25. The learning method according to claim 6, wherein the plurality of psychological state sensitivity expression words include an onomatopoeic word and/or exclamation.

26. The learning method according to claim 6, wherein the estimation model includes a neural network for receiving the two or more two or more psychological state sensitivity expression words up to the certain time-point in the time-point order and for outputting the information associated with the non-fixed ambient environment after the time-point.
